(19) United States
(12) Patent Application Publication
(10) Pub. No.: US 2026/0235289 A1
(43) Pub. Date: Aug. 13, 2026

(54) HEAT SHIELD FOR A FUEL NOZZLE OF A TURBINE ENGINE

(71) Applicant: General Electric Company, Evendale, OH (US)

(72) Inventors: Karthick Gourishankar, Bengaluru (IN); Atanu Saha, Bengaluru (IN); Ramal Janith Samarasinghe, Albany, NY (US); Sanjay Kumar Sondhi, Bengaluru (IN)

(21) Appl. No.: 19/049,681

(22) Filed: Feb. 10, 2025

(51) Int. Cl. F23R 3/28; F02C 7/24

(52) U.S. Cl. CPC F23R 3/283; F05D 2240/15; F05D 2300/2118; F05D 2300/516; F05D 2300/611; F23R 2900/00004

(57) ABSTRACT

A heat shield for a fuel nozzle of a turbine engine includes a shield flange and a ceramic coating. The shield flange has an axial direction, a radial direction, and a circumferential direction. The shield flange includes a flange hot-side surface. The ceramic coating is formed on the flange hot-side surface. The ceramic coating includes a coating hot-side surface, one or more bulk regions, and one or more surface regions. The one or more surface regions are a portion of the coating hot-side surface of the ceramic coating. Each surface region of the one or more surface regions has a surface roughness less than a surface roughness of each bulk region of the one or more bulk regions, a density greater than the density of each bulk region of the one or more bulk regions, or both.

### TECHNICAL FIELD

The present disclosure relates fuel nozzles, particularly, fuel nozzles used in combustors for aircraft engines.

### BACKGROUND

Turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in carbon becoming attached to surfaces contacted by a fuel or an oil and building up as deposits on those surfaces contacted by the fuel or the oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic, cross-sectional view of a turbine engine for an aircraft.

FIG. 2 is a schematic, cross-sectional view of a combustor of the turbine engine shown in FIG. 1. FIG. 2 is a detail view showing detail 2 in FIG. 1.

FIG. 3 is partial a schematic view of a fuel nozzle having an aft heat shield.

FIG. 4 is a schematic, elevational view of a hot-side surface of a ceramic coating that can be used on the aft heat shield shown in FIG. 3.

FIG. 5A is a cross-sectional view of the aft heat shield shown in FIG. 4 taken along line 5-5 in FIG. 4.

FIG. 5B is a cross-sectional view of an aft heat shield, taken from a perspective similar to that of FIG. 5A, showing an alternate ceramic coating structure that can be used on the aft heat shield shown in FIG. 3.

FIG. 6 is a schematic, elevational view of a hot-side surface of a ceramic coating that can be used on the aft heat shield shown in FIG. 3.

FIG. 7 is a cross-sectional view of an aft heat shield with the ceramic coating shown in FIG. 6 taken along line 7-7 in FIG. 6.

FIG. 8A is a detail view of a portion of the ceramic coating for the aft heat shield shown in FIG. 7, showing detail 8A in FIG. 7.

FIG. 8B is a detail view of a portion of the ceramic coating for an aft heat shield taken from a perspective similar to that of FIG. 8A, showing an alternate surface texture.

FIG. 9 is a schematic, elevational view of a hot-side surface of a ceramic coating that can be used on the aft heat shield shown in FIG. 3.

FIG. 10 is a cross-sectional view of an aft heat shield with the ceramic coating shown in FIG. 9 taken along line 10-10 in FIG. 9.

FIG. 11 is a schematic, elevational view of a hot-side surface of a ceramic coating that can be used on the aft heat shield shown in FIG. 3.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed. Various embodiments are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” and the like, may be used interchangeably to distinguish one component from another and are not intended to signify location or importance of the individual components.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

The singular forms “a,” “an,” and “the” include plural references unless the context clearly dictates otherwise.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The term “metallic” as used herein is indicative of a material that is metal-based including metals, such as, but not limited to, titanium, iron, aluminum, stainless steel, and nickel alloys. A metallic material or a metal alloy can be a combination of at least two or more elements or materials where at least one is a metal.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy.

As used herein, the terms “axial” and “axially” refer to directions and orientations that extend substantially parallel to a centerline, such as, for example, a centerline of the turbine engine or an axis of a fuel nozzle. Moreover, the terms “radial” and “radially” refer to directions and orientations that extend substantially perpendicular to these centerlines. In addition, as used herein, the terms “circumferential” and “circumferentially” refer to directions and orientations that extend arcuately about these centerlines.

References to “inner” and “outer” when discussed in the context of radial directions refer to positions relative to the longitudinal centerline of the component.

As used herein, a “hot side” is a side of a component of the turbine engine that is exposed to, or is otherwise oriented to face, a combustion chamber of the combustion section. In the discussion below the hot side of the component may be an aft side or an aft-facing side and, thus, aft-facing may be used interchangeably with hot side in this context.

As used herein, a “cold side” is a side of the combustion section of the turbine engine that is not exposed to, or otherwise not oriented to face, the combustion chamber. In the discussion below, the cold side of the component may be a forward side or a forward-facing side and, thus, forward-facing may be used interchangeably with cold side in this context.

As noted above, coke deposition may occur on surfaces of a turbine engine that are exposed to hydrocarbon fluids, such as fuels and lubricating oils, at elevated temperatures. The fuel nozzle and swirler (collectively, a mixer assembly) used in a combustor for a turbine engine includes such surfaces. The fuel nozzle aft heat shield (AHS) protects the fuel nozzle from hot combustion gases during engine operation. Surfaces of the AHS and other surfaces of the mixer assembly are exposed to hydrocarbon fluids, such as fuel, and operation of the turbine engine, particularly, fuel rich operating conditions, can result in significant build-up of coke and/or partially burned fuel deposits on exposed surfaces of the AHS and the mixer assembly. Such coke deposits can be referred to as operational coke.

Operational coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) results in spallation of the thermal barrier coating and, therefore, reduces the durability of components such as combustors, nozzles, shrouds, and airfoils.

The inventors have observed that this operational coke can build up on the AHS as a continuous ring of coke near the outer rim of the AHS, particularly, under fuel rich combustion conditions. The AHS disclosed herein includes a ceramic coating, such as a TBC coating, having a surface modification for portions of the ceramic coating. The surface modifications discussed herein reduce the driving force for coke adhesion to the AHS, breaking up the coke deposits as the deposit forms and preventing the formation of a large continuous coke ring. This reduces the potential for large flakes of coke to form, leading to a more benign situation for erosion of downstream components.

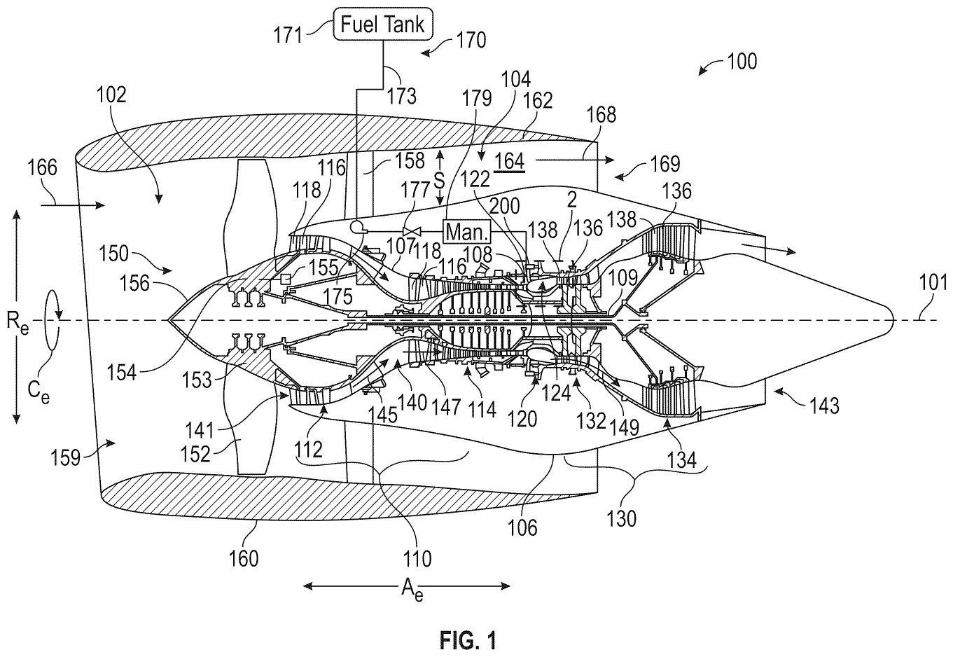

FIG. 1 is a schematic, cross-sectional view of a turbine engine 100 that may be used on an aircraft. The turbine engine 100 has an axial direction (engine axial direction Aₑ) (extending parallel to a longitudinal centerline axis 101, shown for reference in FIG. 1), a radial direction (engine radial direction Rₑ), and a circumferential direction (engine circumferential direction Cₑ). The engine circumferential direction Cₑ extends in a direction rotating about the engine axial direction Aₑ. In the embodiment depicted in FIG. 1, the turbine engine 100 is a high bypass turbofan engine, including a fan section 102 and a turbo-engine 104 disposed downstream from the fan section 102.

The turbo-engine 104 depicted in FIG. 1 includes, in serial flow relationship, a compressor section 110, a combustion section 120, and a turbine section 130. The turbo-engine 104 is substantially enclosed within an outer casing 106 that is substantially tubular and defines a core inlet 141. In this embodiment, the core inlet 141 is annular. As schematically shown in FIG. 1, the compressor section 110 includes a booster or a low-pressure (LP) compressor 112 followed downstream by a high-pressure (HP) compressor 114. The combustion section 120 is downstream of the compressor section 110. The turbine section 130 is downstream of the combustion section 120 and includes a high-pressure (HP) turbine 132 followed downstream by a low-pressure (LP) turbine 134. The turbo-engine 104 further includes a core air exhaust nozzle 143 (also referred to as a jet exhaust nozzle) that is downstream of the turbine section 130. The compressor section 110, the combustion section 120, and the turbine section 130 together define, at least in part, a core air flow path 140 extending from the core inlet 141 to the core air exhaust nozzle 143, and through which core air 145 flows. As will be discussed in more detail below, the turbo-engine 104 includes a high-pressure (HP) shaft 108, and a low-pressure (LP) shaft 109. The HP shaft 108 drivingly connects the HP turbine 132 to the HP compressor 114. The HP turbine 132 and the HP compressor 114 rotate in unison through the HP shaft 108. The LP shaft 109 drivingly connects the LP turbine 134 to the LP compressor 112. The LP turbine 134 and the LP compressor 112 rotate in unison through the LP shaft 109.

Each of the LP compressor 112 and the HP compressor 114 may include a plurality of compressor stages. In each stage, a plurality of compressor blades 116 rotates relative to a corresponding plurality of static compressor vanes 118 (also called nozzles) to compress or to pressurize the core air 145 passing through the stage. In a single compressor stage, the plurality of compressor blades 116 can be provided in a ring, extending radially outwardly relative to the longitudinal centerline axis 101 from a blade platform to a blade tip (e.g., extend in the engine radial direction Re). The compressor blades 116 may be a part of a compressor rotor that includes a disk and each compressor blade 116 of the plurality of compressor blades 116 extends radially from the disk. Other configurations of the compressor rotor may be used, including, for example, blisks where the disk and the compressor blades 116 are integrally formed with each other to be a single piece. The corresponding static compressor vanes 118 are positioned upstream of and adjacent to the rotating compressor blades 116. The compressor vanes 118 for a stage of the compressor can be mounted to a core casing 107 in a circumferential arrangement.

The core casing 107 may define, at least in part, the core air flow path 140. Each compressor stage may be used to sequentially compress the core air 145 flowing through the core air flow path 140, generating compressed air 147. Any suitable number of compressor blades 116, compressor vanes 118, and compressor stages may be used.

Each of the HP turbine 132 and the LP turbine 134 also may include a plurality of turbine stages. In each stage, a plurality of turbine blades 136 rotates relative to a corresponding plurality of static turbine vanes 138 (also called a nozzle) to extract energy from combustion gases 149 passing through the stage. The turbine blades 136 may be a part of a turbine rotor.

Any suitable configuration for a turbine rotor may be used, including, for example, a disk with the plurality of turbine blades 136 extending from the disk. The corresponding static turbine vanes 138 are positioned upstream of and adjacent to the rotating turbine blades 136. The turbine vanes 138 for a stage of the turbine can be mounted to the core casing 107 in a circumferential arrangement.

In the combustion section 120, fuel, received from a fuel system 170, is injected into a combustion chamber 124 of a combustor 122 by fuel nozzles 200. The fuel is mixed with the compressed air 147 from the compressor section 110 to form a fuel and air mixture, and combusted, generating combustion products (i.e., combustion gases 149). Adjusting a fuel metering unit 177 of the fuel system changes the volume of fuel provided to the combustion chamber 124 and, thus, changes the amount of propulsive thrust produced by the turbine engine 100 to propel the aircraft. The combustion gases 149 are discharged from the combustion chamber 124. These combustion gases may be directed into the turbine blades 136 of the HP turbine 132 and, then, the turbine blades 136 of the LP turbine 134, and the combustion gases 149 drive (rotate) the turbine blades 136 of the HP turbine 132 and the LP turbine 134.

Any suitable number of turbine blades 136, turbine vanes 138, and turbine stages may be used. After flowing through the turbine section 130, the combustion gases 149 are exhausted from the turbine engine 100 through the core air exhaust nozzle 143 to provide propulsive thrust.

The turbine engine 100 is operable with the fuel system 170 and receives a flow of fuel from the fuel system 170. An aviation turbine fuel used in the embodiments discussed herein may be a combustible hydrocarbon liquid fuel, such as a kerosene-type fuel, having a desired carbon number, for example, Jet A fuel. But other suitable fuels may be used including, for example, sustainable aviation fuels (SAF), including biofuels, and the like. The fuel is stored in a fuel tank 171 of the fuel system 170. The fuel tank 171 or at least a portion thereof can be located on board the aircraft, such as, for example, in a fuselage of the aircraft, in one or both wings of the aircraft, or both. The fuel tank 171 also can be separate tanks instead of a single, unitary body, such as, for example, two tanks each located within a corresponding wing.

The fuel system 170 includes a fuel delivery assembly 173 providing the fuel flow from the fuel tank 171 to the turbine engine 100, and, more specifically, to the plurality of fuel nozzles 200. The components of the fuel system 170, and, more specifically, the fuel tank 171, is an example of a fuel source that provides fuel to the fuel nozzles 200. The fuel delivery assembly 173 includes tubes, pipes, conduits, and the like, to fluidly connect the various components of the fuel system 170 to the turbine engine 100. The fuel tank 171 is configured to store the fuel, and the fuel is supplied from the fuel tank 171 to the fuel delivery assembly 173. The fuel delivery assembly 173 is configured to carry the fuel between the fuel tank 171 and the turbine engine 100 and, thus, provides a flow path (fluid pathway) of the fuel from the fuel tank 171 to the turbine engine 100.

The fuel system 170 includes at least one fuel pump fluidly connected to the fuel delivery assembly 173 to pressurize, to induce, or both, the flow of the fuel through the fuel delivery assembly 173 to the turbine engine 100. One such pump is a main fuel pump 175. The main fuel pump 175 can be a high-pressure pump that is the primary source of pressure rise in the fuel delivery assembly 173 between the fuel tank 171 and the turbine engine 100. The main fuel pump 175 can be configured to increase a pressure in the fuel delivery assembly 173 to a pressure greater than a pressure within the combustion chamber 124 of the combustor 122.

The fuel system 170 also includes a fuel metering unit 177 in fluid communication with the fuel delivery assembly 173. Any suitable fuel metering unit 177 may be used including, for example, a metering valve or a metering valve assembly. The fuel metering unit 177 is positioned downstream of the main fuel pump 175 and upstream of a fuel manifold 179 configured to distribute fuel to the fuel nozzles 200. The fuel system 170 is configured to provide the fuel to the fuel metering unit 177, and the fuel metering unit 177 is configured to receive fuel from the fuel tank 171. The fuel metering unit 177 is further configured to provide a flow of fuel to the turbine engine 100 in a desired manner. More specifically, the fuel metering unit 177 is configured to meter the fuel and to provide a desired volume of fuel, at, for example, a desired flow rate, to the fuel manifold 179 of the turbine engine 100. The fuel manifold 179 is fluidly connected to the fuel nozzles 200 and distributes (provides) the fuel received to the plurality of fuel nozzles 200, where the fuel is injected into the combustion chamber 124 and combusted. Adjusting the fuel metering unit 177 changes the volume of the fuel provided to the combustion chamber 124 and, thus, changes the amount of propulsive thrust produced by the turbine engine 100 to propel the aircraft.

The turbine engine 100 and, more specifically, the turbo-engine 104 further includes one or more drive shafts. As noted above, the turbo-engine 104 includes the high-pressure (HP) shaft 108 drivingly connecting the HP turbine 132 to the HP compressor 114, and the low-pressure (LP) shaft 109 drivingly connecting the LP turbine 134 to the LP compressor 112.

More specifically, the turbine rotors of the HP turbine 132 are connected to the HP shaft 108, and the compressor rotors of the HP compressor 114 are connected to the HP shaft 108. The combustion gases 149 are routed into the HP turbine 132 and expanded through the HP turbine 132 where a portion of thermal energy or kinetic energy from the combustion gases 149 is extracted via the one or more stages of the turbine blades 136 and turbine vanes 138 of the HP turbine 132. This causes the HP shaft 108 to rotate, which supports operation of the HP compressor 114 (self-sustaining cycle) and rotating the compressor rotors and, thus, the compressor blades 116 of the HP compressor 114 via the HP shaft 108. In this way, the combustion gases 149 do work on the HP turbine 132. The combustion gases 149 are then routed into the LP turbine 134 and expanded through the LP turbine 134. Here, a second portion of the thermal energy or the kinetic energy is extracted from the combustion gases 149 via one or more stages of the turbine blades 136 and the turbine vanes 138 of the LP turbine 134. This causes the LP shaft 109 to rotate, which supports operation of the LP compressor 112 (self-sustaining cycle), and rotation of the compressor rotors and, thus, the compressor blades 116 of the LP compressor 112 via the LP shaft 109. In this way, the combustion gases 149 do work on the LP turbine 134. The HP shaft 108 and the LP shaft 109 are disposed coaxially about the longitudinal centerline axis 101. The HP shaft 108 has a diameter greater than that of the LP shaft 109, and the HP shaft 108 is located radially outward of the LP shaft 109. The HP shaft 108 and the LP shaft 109 are rotatable about the longitudinal centerline axis 101 and, as discussed above, coupled to rotatable elements such as the compressor rotors and the turbine rotors.

The fan section 102 shown in FIG. 1 includes a fan 150 having a plurality of fan blades 152 coupled to a disk 153. As depicted in FIG. 1, the fan blades 152 extend outwardly from the disk 153 generally along the engine radial direction Re. In the case of a variable pitch fan, as depicted in FIG. 1, for example, the plurality of fan blades 152 is rotatable relative to the disk 153 about a pitch axis P. Each of the fan blades 152 can be connected to the disk 153 by a pitch bearing 154 that allows for rotation of the fan blades 152 about the pitch axis P. The fan blades 152 are rotatable within the pitch bearing 154 by an actuator 155 operatively coupled to the fan blades 152 to collectively vary the pitch of the fan blades 152 in unison. The fan blades 152 and the disk 153 are rotatable, together, about the longitudinal centerline (axis) 101 by the LP shaft 109. The LP compressor 112 may also be directly driven by the LP shaft 109, as depicted in FIG. 1. The disk 153 is covered by a fan hub 156 aerodynamically contoured to promote an airflow through the plurality of fan blades 152. Further, a nacelle 160 circumferentially surrounds the fan 150, and, in the depicted embodiment, at least a portion of the turbo-engine 104. The nacelle 160 may also be referred to as an annular fan casing or an outer nacelle. The nacelle 160 is supported relative to the turbo-engine 104 and, more specifically, the outer casing 106 by a plurality of outlet guide vanes 158 that is circumferentially spaced about the nacelle 160 and the turbo-engine 104. A downstream section 162 of the nacelle 160 extends over an outer portion of the turbo-engine 104 and, more specifically, the outer casing 106 so as to define a bypass airflow passage 164 therebetween.

During operation of the turbine engine 100, a volume of air 166 enters the turbine engine 100 through an inlet of the nacelle 160 and/or the fan section 102 (referred to herein as an engine inlet 159). As the volume of air 166 passes across the fan blades 152, a first portion of air (bypass air 168) is directed or routed into the bypass airflow passage 164, and a second portion of air (core air 145) is directed or is routed into an upstream section of the core air flow path 140, or, more specifically, into the core inlet 141. The ratio between the bypass air 168 and the core air 145 is commonly known as a bypass ratio. Simultaneously with the flow of the core air 145 through the core air flow path 140 (as discussed above), the bypass air 168 is routed through the bypass airflow passage 164 before being exhausted from a bypass air discharge nozzle 169 of the turbine engine 100, also providing propulsive thrust. The bypass air discharge nozzle 169 and the core air exhaust nozzle 143 are air exhaust nozzles of the turbine engine 100.

The turbine engine 100 shown in FIG. 1 and discussed herein (i.e., a turbofan engine) is provided by way of example only. In other embodiments, any other suitable engine may be utilized with aspects of the present disclosure. For example, in other embodiments, the engine may be any other suitable turbine engine, such as a turboshaft engine, a turboprop engine, a turbojet engine, an unducted single fan engine, and the like. In such a manner, in other embodiments, the turbine engine may have other suitable configurations, such as other suitable numbers or arrangements of shafts, compressors, turbines, fans, etc. Further, although the turbine engine 100 is shown as a direct drive, fixed-pitch turbofan engine, in other embodiments, the turbine engine 100 may be a geared turbine engine (e.g., including a gearbox between the fan 150 and a shaft driving the fan, such as the LP shaft 109), may be a variable pitch turbine engine (i.e., including a fan 150 having a plurality of fan blades 152 rotatable about their respective pitch axes), etc. Further, still, in alternative embodiments, aspects of the present disclosure may be incorporated into, or otherwise utilized with, any other type of engine, such as reciprocating engines.

The turbine engine 100 discussed herein is suitable for use on aircraft. Suitable aircraft include, for example, airplanes, helicopters, and unmanned aerial vehicles (UAV). In other embodiments, the turbine engine may be any other turbine engine, such as an industrial turbine engine incorporated into a power generation system, or a nautical turbine engine on a ship or other vessel.

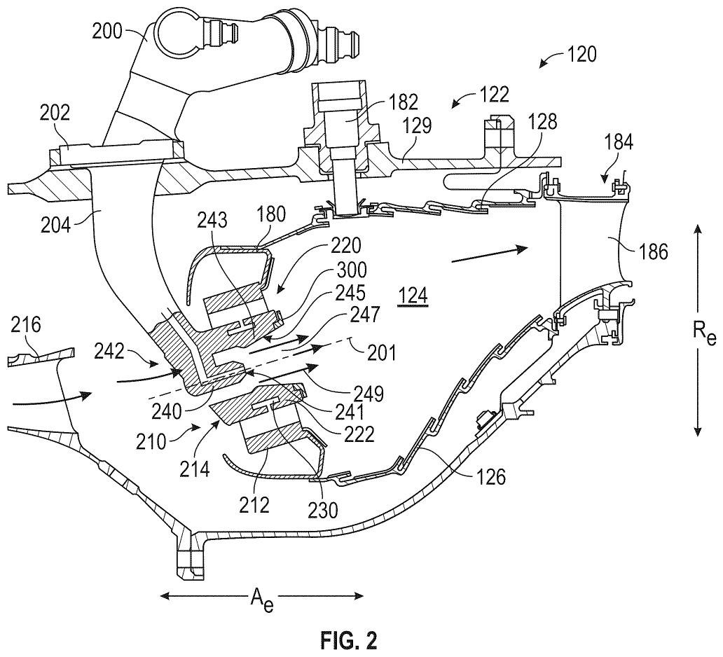

FIG. 2 is a schematic, cross-sectional view of the combustor 122 of the combustion section 120 according to an embodiment of the present disclosure. Specifically, FIG. 2 is a detail view showing detail 2 in FIG. 1. The combustor 122 is an annular combustor that includes the combustion chamber 124 defined between an inner combustion liner 126 and an outer combustion liner 128. Each of the inner combustion liner 126 and outer combustion liner 128 is annular about the longitudinal centerline axis 101 of the turbine engine 100 (FIG. 1), and may thus extend in the engine circumferential direction Cₑ (FIG. 1). The combustor 122 also includes a combustor case 129 that is also annular about the longitudinal centerline axis 101 of the turbine engine 100. The combustor case 129 extends circumferentially around the inner combustion liner 126 and the outer combustion liner 128, and the inner combustion liner 126 and outer combustion liner 128 are located radially inward of the combustor case 129. The combustor 122 also includes a dome 180 mounted to a forward end of each of the inner combustion liner 126 and the outer combustion liner 128. The dome 180 defines an upstream end (or forward end) of the combustion chamber 124.

A plurality of mixer assemblies 210 (only one is illustrated in FIG. 2) is spaced around the dome 180. The plurality of mixer assemblies 210 is circumferentially spaced about the longitudinal centerline axis 101 of the turbine engine 100. In the embodiment shown in FIG. 2, each mixer assembly 210 is a twin annular premixing swirler (TAPS) that includes a main mixer 212 and a pilot mixer 214. The pilot mixer 214 is supplied with fuel from the fuel nozzle 200 during the entire engine operating cycle, and the main mixer 212 is supplied with fuel from the fuel nozzle 200 only during increased power conditions of the engine operating cycle, such as take-off and climb, for example. As discussed in more detail below, fuel nozzle 200 includes an aft heat shield 300. The TAPS mixer assembly 210 is provided by way of example and aft heat shield 300 herein may be used with other mixer assembly designs and other combustor designs, including, for example, rich burn combustors and mixer assemblies.

As noted above, the compressor section 110, including the HP compressor 114 (FIG. 1), pressurizes air, and the combustor 122 receives an annular stream of this pressurized air from a discharge outlet (e.g., a compressor discharge outlet 216) of the HP compressor 114. This air may be referred to as compressor discharge air. A portion of the compressor discharge air flows into the mixer assembly 210. Fuel is injected into the air in the mixer assembly 210 to mix with the air and to form a fuel-air mixture. The fuel-air mixture is provided to the combustion chamber 124 from the mixer assembly 210 for combustion. Ignition of the fuel-air mixture is accomplished by a suitable igniter 182, and the resulting combustion gases flow in the engine axial direction Ae toward and into an annular, first stage turbine nozzle 184. The first stage turbine nozzle 184 is defined by an annular flow channel that includes a plurality of radially extending, circularly-spaced first stage nozzle vanes 186 that turn the gases so that they flow angularly and impinge upon the first stage turbine blades (not shown) of a first turbine (not shown) of the HP turbine 132 (FIG. 1). The first stage nozzle vanes 186 are examples of the turbine vanes 138 discussed above.

The fuel nozzle 200 is fixed to the combustor case 129 by a nozzle mount. In this embodiment, the nozzle mount is a flange 202 that is integrally formed with a stem 204 of the fuel nozzle 200. The flange 202 is fixed to the combustor case 129 and sealed to the combustor case 129. The stem 204 includes one or more flow passages through which the fuel flows, and the stem 204 extends radially inward from the flange 202. The fuel nozzle 200 also includes a fuel nozzle tip 220 through which fuel is injected into the combustion chamber 124 as part of the mixer assembly 210.

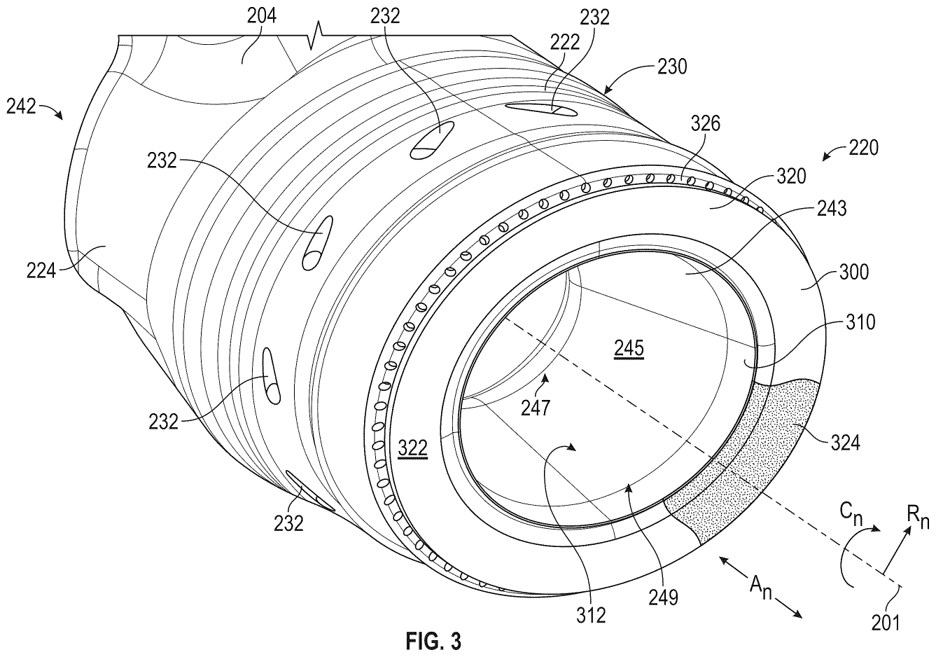

The fuel nozzle tip 220 includes a fuel nozzle body 222 and an aft heat shield 300. The aft heat shield 300 is attached to the fuel nozzle body 222. The fuel nozzle body 222 is mounted to an inlet fairing 224 (FIG. 3). The inlet fairing 224 is connected to or integral with the stem 204. The fuel nozzle body 222 includes a main fuel nozzle 230 and a pilot fuel injector tip 240. The pilot fuel injector tip 240 includes at least one pilot fuel orifice 241. The pilot fuel injector tip 240 can be a dual orifice pilot fuel injector tip having a primary pilot fuel orifice and a secondary pilot fuel orifice. The dual orifice pilot fuel injector tip 240 may be substantially centered in an annular pilot inlet 242. The main fuel nozzle 230 surrounds the pilot inlet 242, and the pilot inlet 242 is located between the main fuel nozzle 230 and the dual orifice pilot fuel injector tip 240. In this embodiment, the fuel nozzle tip 220 is circular about an axis (referred to herein as a fuel nozzle axis 201) extending through the center of the pilot fuel orifice 241 (e.g., the primary pilot fuel orifice in the case of a dual pilot fuel nozzle tip). In the discussion below, various features of the fuel nozzle tip 220 may be discussed relative to this axis (the fuel nozzle axis 201).

Fuel is provided through the stem 204 to the primary pilot fuel orifice and the secondary pilot fuel orifice of the pilot fuel injector tip 240. The pilot mixer 214 includes pilot swirlers causing air traveling therethrough to swirl. A portion of the compressor discharge air flows into the mixer assembly pilot inlet 242 and, then, into the pilot swirlers. As noted above, fuel and air are provided to the pilot mixer 214 at all times during the engine operating cycle so that a primary combustion zone is produced within a central portion of the combustion chamber 124. The pilot fuel orifice 241 injects the fuel in a generally downstream direction and into the compressed air flowing through the pilot swirlers. The pilot mixer 214 is supported by pilot housing 243. The pilot housing 243 can be annular. The pilot housing 243 includes a conical wall section 245 circumscribing a pilot mixing chamber 247 that is in flow communication with, and downstream from, the pilot mixer 214. The pilot mixing chamber 247 can be conical. The fuel and air mixture flows through the pilot mixing chamber 247, where the fuel and the air are further mixed, through an outlet 249 of the pilot mixing chamber 247, and into the combustion chamber 124.

FIG. 3 is a partial, schematic view of a portion of the fuel nozzle 200. Fuel also is provided through the stem 204 to the main fuel nozzle 230 and, more specifically, to an annular main fuel passage of an annular main fuel ring. The main fuel nozzle 230 includes a circular array of main fuel injection orifices 232 (or an annular array of main fuel injection orifices 232) extending radially outward from the annular main fuel passage and through the wall of the annular main fuel ring. The main fuel nozzle 230 and the annular main fuel ring are spaced radially outward of the primary pilot fuel orifice and the secondary pilot fuel orifice. The main fuel nozzle 230 injects fuel in a radially outward direction through the circular array of main fuel injection orifices 232.

As noted above, the fuel nozzle tip 220 includes the fuel nozzle axis 201, and various features of the fuel nozzle tip 220 may be discussed relative to the fuel nozzle axis 201. The fuel nozzle (fuel nozzle tip 220) has an axial direction (a nozzle axial direction Aₙ) (extending parallel to the fuel nozzle axis 201), a radial direction (a nozzle radial direction Rₙ), and a circumferential direction (a nozzle circumferential direction Cₙ). The nozzle circumferential direction Cₙ extends in a direction rotating about the nozzle axial direction Aₙ.

The fuel nozzle tip 220 extends into the combustion chamber 124 (FIG. 2) and is adjacent to the primary combustion zone. The pilot housing 243, and the aft heat shield 300 are exposed to high temperatures. For example, the conical wall section 245 of the pilot housing 243 and the aft heat shield 300 may be exposed to gas temperatures from six hundred degrees Fahrenheit (600° F.) to three thousand eight hundred degrees Fahrenheit (3,800°F). The pilot housing 243 and the aft heat shield 300 are made from materials suitable for use in these high temperature environments including, for example, stainless steel, corrosion-resistant alloys of nickel and chromium, and high-strength nickel-base alloys. The pilot housing 243 and the aft heat shield 300 may thus be formed from a metal alloy chosen from the group consisting of iron-based alloys, nickel-based alloys, and chromium-based alloys. In some embodiments, cobalt-based alloys may also be used.

The aft heat shield 300 includes an inner wall 310. The inner wall 310 may be annular defining a heat-shield bore 312. The inner wall 310 may be an axially extending sidewall that extends in the nozzle axial direction An into the pilot mixing chamber 247. The inner wall 310 may form a portion of the conical wall section 245, and a forward end of inner wall 310 may abut an aft end the conical wall section 245 to provide a generally continuous conical section of the pilot mixing chamber 247 with the heat-shield bore 312 forming a portion of the pilot mixing chamber 247. The inner wall 310 can be attached to the pilot housing 243 to connect the aft heat shield 300 to the fuel nozzle tip 220. The inner wall 310 can be attached to the pilot housing 243 by any suitable means including, for example, fusion bonding processes, such as brazing, welding, or the like. The aft heat shield 300 also includes a shield flange 320 at an aft end of the inner wall 310. The shield flange 320 is annular and extends radially outward from the fuel nozzle axis 201 and may be referred to herein as an annular ring. The shield flange 320 may include an aft-facing surface 322. The aft-facing surface 322 is a surface facing the combustion chamber 124 and is, thus, a hot-side surface. The aft-facing surface 322 may be referred to herein as a flange hot-side surface. The aft-facing surface 322 can be a planar surface. The aft-facing surface 322 can be orthogonal to the fuel nozzle axis 201.

The aft-facing surface 322 can be coated with a thermal barrier coating (TBC) 324 to insulate the fuel nozzle tip 220 from the heat from combustion. In FIG. 3, the TBC 324 is only shown on a portion of the aft-facing surface 322. The TBC 324 can be a coating with a high thermal resistivity, such as ceramic materials. The shield flange 320 also has an outer edge 326, such as the radially outermost edge of the shield flange 320. As noted above, the aft heat shield 300 is attached to the distal end of the fuel nozzle tip 220. The fuel nozzle tip 220 is located on a cold side of the shield flange 320. The aft heat shield 300 (more specifically, the shield flange 320 with the TBC 324 formed thereon), insulates components on the cold side of the aft heat shield 300, such as the fuel nozzle tip 220, from heat of combustion that results from combustion of the fuel in the combustion chamber 124. The aft heat shield 300 (more specifically, the shield flange 320 with the TBC 324 formed thereon) is located closer to a combustion zone within the combustion chamber 124 than the fuel nozzle tip 220. The aft heat shield 300 is positioned between the combustion zone within the combustion chamber 124 and the fuel nozzle tip 220 to shield the fuel nozzle 200 (more specifically, the fuel nozzle tip 220) from the heat of combustion.

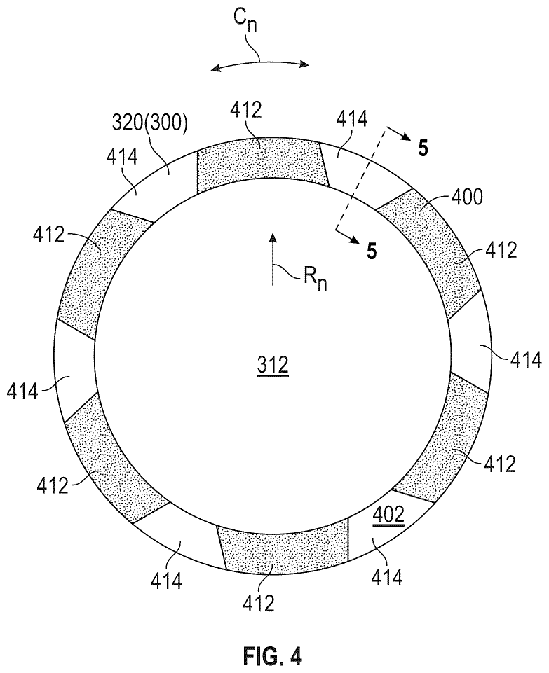

FIG. 4 is a schematic, elevational view of a ceramic coating 400 that can be used as the TBC 324 of the aft heat shield 300 in FIG. 3. More specifically, FIG. 4 shows a hot-side surface 402 of the ceramic coating 400. The hot-side surface 402 is the surface of the ceramic coating 400 that faces the combustion chamber 124 (FIG. 2). As noted above, the shield flange 320 also includes a flange hot-side surface, which is also referred to herein as the aft-facing surface 322 (FIG. 3). To distinguish the hot-side surface 402 of the ceramic coating 400 from the flange hot-side surface, the hot-side surface 402 of the ceramic coating 400 also may be referred to herein as a coating hot-side surface. The hot-side surface 402 of the ceramic coating 400 is an exposed surface or a wetted surface, which is exposed to the fluids in the combustion chamber 124, such as the fuel, which can be a hydrocarbon fluid. With the high temperatures (discussed above) and combustion, coke may begin to form on the aft heat shield 300. More specifically, coke may begin to form on the exposed surface of the aft heat shield 300, which is the hot-side surface 402 of the ceramic coating 400.

As noted above, coke deposition may occur on surfaces of a turbine engine that are exposed to hydrocarbon fluids, such as fuels and lubricating oils, at elevated temperatures. The fuel nozzle and the swirler (collectively, a mixer assembly) used in a combustor for a turbine engine includes such surfaces. The fuel nozzle aft heat shield (AHS) protects the fuel nozzle from hot combustion gases during engine operation. Surfaces of the AHS and other surfaces of the mixer assembly are exposed to hydrocarbon fluids, such as fuel, and operation of the turbine engine, particularly, fuel rich operating conditions, can result in significant build-up of coke and/or partially burned fuel deposits on exposed surfaces of the AHS and the mixer assembly.

Such coke deposits can be referred to as operational coke. As noted above, the inventors have observed that operational coke can build up on the aft heat shield 300 as a continuous ring of coke (e.g., a coke ring) on the hot-side surface 402 of the ceramic coating 400. The hot-side surface 402 of the ceramic coating 400 shown in FIG. 4 has surface treatments applied thereto to break up this coke ring.

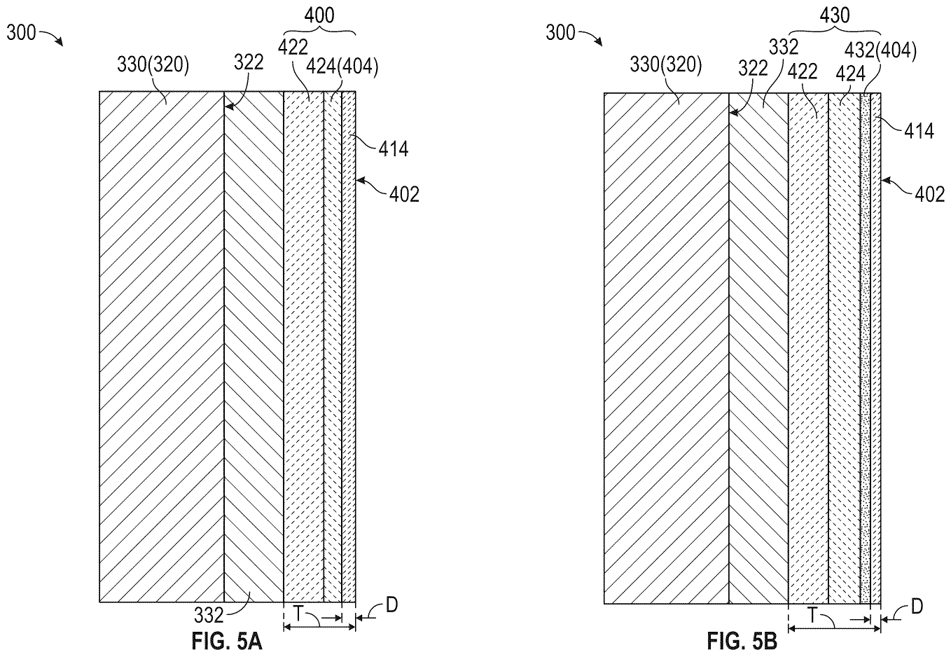

The ceramic coating 400 can be applied to a substrate 330 (FIG. 5A). The substrate 330 can be a metal substrate. For example, the substrate 330 can be the shield flange 320 of the aft heat shield 300 formed from the metals discussed above. The ceramic coating 400 can be applied to the substrate 330 using various coating processes. For example, the ceramic coating 400 can be applied by spray coating processes, such as thermal spray coating processes. Such spray coating processes can include, for example, air plasma spray, physical vapor, chemical vapor deposition, slurry spray, suspension plasma spray, and solution precursor plasma spray.

Additional processing, such as various heat treatments, may be used to consolidate or otherwise process the ceramic coating 400. The hot-side surface 402 of the ceramic coating 400 can have an as-applied surface roughness. This as applied surface roughness (Ra) can be, for example, from three hundred (300) micro-inches (7.62 μm) to one thousand (1000) micro-inches (25.4 μm). The as applied or as formed density of the ceramic coating 400 can be sixty-five (65) percent to ninety (90) percent by volume percent of the ceramic coating.

To break up the coke ring, the ceramic coating 400 has a plurality of regions, including one or more bulk regions 412 and one or more surface regions 414. The bulk regions 412 can be as applied regions or as formed regions of the ceramic coating 400. The bulk regions thus can have the as applied surface roughness, the as formed density, or both, of the ceramic layer as discussed above. The surface regions 414 can be formed by polishing, burnishing, or glazing portions of the hot-side surface 402 of the ceramic coating 400.

As shown in FIG. 4, example, the ceramic coating 400 can include a plurality of surface regions 414 spaced apart from each other in the nozzle circumferential direction Cₙ. The ceramic coating 400 can also include a plurality of bulk regions 412 that are also spaced apart from each other in the nozzle circumferential direction Cₙ. The bulk regions 412 and the surface regions 414 can be formed in an alternating arrangement with adjacent bulk regions 412 separated by a surface region 414 and adjacent surface regions 414 separated by a bulk region 412.

The surface regions 414 can have a surface roughness that is less than a surface roughness of the bulk region, a density greater than the density of the bulk region, or both. For example, the surface roughness (Ra) of each surface region 414 can be from one (1) micro-inch (0.0254 μm) to one hundred fifty (150) micro-inches (3.81 μm), such as from ten (10) micro-inches (0.254 μm) to eighty (80) micro-inches (2.0 μm). Particles are known to easily adhere to surfaces with a surface roughness (Ra) of three hundred (300) micro-inch (7.62 μm) or greater.

Reducing the surface roughness (Ra) makes particle adherence more difficult and a surface roughness (Ra) of one hundred fifty (150) micro-inches (3.81 μm) or less is set to limit adherence of coke. The smoother the surface the less particles will adhere to the surface and, based on experience, a surface roughness (Ra) of eighty (80) micro-inches (2.0 μm) inhibits the adherence of even fine particles (e.g., a particle distribution with a D50 size of 2 micron). As noted above, the surface regions can interrupt and prevent the formation of relatively large coke deposits (such as a continuous ring), and so a completely smooth surface is not necessary. Thus, when taking manufacturability into consideration and balancing manufacturability with the objectives of the surface regions, a surface roughness (Ra) one (1) micro-inch (0.0254 μm) or greater, such as ten (10) micro-inches (0.254 μm) or greater can be used. With the values for the bulk regions 412 discussed above, the surface roughness of each surface region 414 can be from 0.1 percent to fifty (50) percent the surface roughness of the bulk region, such as from one percent to twenty percent the surface roughness of the bulk region. The smooth surfaces of the surface regions 414 tend to reduce adhesion and retention of the coke on the surfaces of these regions, thus reducing the formation of large continuous coke rings. Additionally, the alternating arrangement of the bulk regions 412 and the surface regions 414 creates discontinuities in the kinetics of coke formation, leading to a disruption in the formation of a continuous coke ring, and reducing the overall build-up of coke.

FIG. 5A is a cross-sectional view of the aft heat shield 300, taken along line 5-5 in FIG. 4, with the ceramic coating 400 shown in FIG. 4. FIG. 5A is a cross section taken through a surface region 414. As noted above, the aft heat shield 300 includes a shield flange 320 with an aft-facing surface 322. The ceramic coating 400 can be applied to the aft-facing surface 322 of the shield flange 320 and the shield flange 320 can be the substrate 330 on which the ceramic coating 400 is formed. As noted above, the shield flange 320 and, thus, the substrate 330 can be a metal substrate.

Instead of the ceramic coating 400 being formed directly on the substrate 330, a bonding layer 332, which can also be referred to as a bond coat, can be applied to the substrate 330 and, then, the ceramic coating 400 is formed on the bonding layer 332. The bonding layer 332 can help to increase the adhesion between the ceramic coating 400 and the substrate 330. The bonding layer 332 can be a material that is compatible with the material of each of the substrate 330 and the ceramic coating 400. The bonding layer 332 can be, for example, an alloy comprising a base metal element M, and additional alloying elements such as chromium (Cr), aluminum (Al), yttrium (Y), or combinations thereof. The base metal element M can be nickel (Ni), cobalt (Co), or iron (Fe). The base metal element M can be the same as that of the substrate 330. The bonding layer 332 can be, for example, an MCrAIY alloy, where the base metal M is nickel (Ni), cobalt (Co), or iron (Fe). Other materials used for the bonding layer 332 can include platinum aluminide and other aluminides. The bonding layer 332 can be applied using a thermal spray process, like plasma spraying, resulting in a rough, porous surface that further enhances the mechanical bond between the substrate 330 and the ceramic coating 400.

The ceramic coating 400 can be a stabilized ceramic that can sustain a fairly high temperature gradient such that the coated metallic components can be operated at gas temperatures higher than the melting point of the metal, so that the ceramic coating 400 can be used as the TBC 324 and exposed to the temperature discussed above. For instance, the material of the ceramic coating 400 can be one or more of yttria stabilized zirconia (YSZ) and other rare-earth-stabilized zirconia compositions, mullite (3Al₂O₃-2SiO₂), alumina (Al₂O₃), ceria (CeO₂), rare-earth zirconates (e.g., La₂Zr₂O₇), rare-earth oxides (e.g., La₂O₃, Nb₂O₅, Pr₂O₃, CeO₂), and metal-glass composites, including combinations thereof (e.g., alumina and YSZ or ceria and YSZ). For example, the ceramic coating 400 can be yttria-stabilized zirconia (YSZ).

The ceramic coating 400 can be a single layer ceramic coating, or a multi-layer ceramic coating. When the ceramic coating 400 is a multi-layer coating, the ceramic coating 400 includes an outer layer 404, on which the hot-side surface 402 is formed, and, in which, the surface regions 414 are formed. The ceramic coating 400 shown in FIG. 5A is a bi-layer ceramic coating with a first layer 422 and a second layer 424. The second layer 424 is the outer layer 404. The first layer 422 can be formed between the second layer 424 and the substrate 330, such as sandwiched between the second layer 424 and the bonding layer 332. The first layer 422 and the second layer 424 can be different ceramic materials or similar materials with different compositions. For example, both the first layer 422 and the second layer 424 can be YSZ, but have differing amounts (e.g., percentage) of yttrium oxide (Y₂O₃) that is used to stabilize the zirconia (ZrO₂) crystal structure. The second layer 424 can have a greater amount of yttrium oxide than the first layer 422, such as the first layer 422 having eight percent yttrium oxide (8YSZ) and the second layer 424 having fifty-five percent yttrium oxide (55YSZ).

As noted above, the surface regions 414 can be portions of the ceramic coating 400 that have a greater density than the densities of the bulk regions 412 (FIG. 4). The bulk regions 412 can have an as formed density, which may be referred to herein as a bulk density, such as those discussed above. The surface regions 414, however, can have a density that is greater than the bulk density. The density of the bulk regions 412 can be from sixty-five percent to ninety-five percent of the density of the surface regions 414. The density of each surface region 414 can be, for example, from eighty (80) percent to ninety-eight (98) percent by volume percent of the surface region 414. Coke forms and adheres more strongly on porous surfaces, and thus decreasing the porosity (i.e., increasing the density) of the ceramic coating 400 at the hot-side surface 402 impedes formation and adherence of coke, similarly to the smoother surfaces of the surface regions 414, as discussed above. Accordingly, the intermittent denser surface regions 414 help to break up the formation of the coke ring.

The ceramic coating 400 has a total thickness T, which, in the case of a multi-layer ceramic coating, includes the thickness of each layer (e.g., the first layer 422 and the second layer 424). As noted above, the surface regions 414 can be formed by a surface treatment applied to the ceramic coating 400 after the ceramic coating 400 has been formed on the substrate 330. Each surface region 414 can thus have a surface depth D. The surface depth D can be a depth into the ceramic coating 400 from the hot-side surface 402, in which densification imparted to the bulk density has occurred, with the remaining portion of the ceramic coating 400 between the surface regions 414 and the substrate 330 having the bulk density. While the transitions between the density of the surface region 414 and the bulk density can be a sharp transition, the density change can be gradual. When the density change is gradual, the surface depth D can be the location where the density is below the lower range for the increased density discussed above, such as eighty (80) percent.

The porosity of the ceramic coating 400 helps to prevent thermal transfer and, thus, helps to protect the fuel nozzle tip 220 (FIG. 2). Accordingly, the surface regions 414 can each have a surface depth D that is less than the total thickness T of the ceramic coating 400. The total thickness T of the ceramic coating 400 can be, for example, from two hundred fifty microns (250 μm) to three hundred microns (300 μm). The surface depth D can be from five microns (5 μm) to fifty microns (50 μm), such as from five microns (5 μm) to twenty-fifty microns (25 μm). The surface depth D of each surface region 414 thus can be from one and a half (1.5) percent to twenty (20) percent of the total thickness T of the ceramic coating 400, such as from one and a half (1.5) percent to ten (10) percent of the total thickness T of the ceramic coating 400. With such surface depths D, the thermal performance decrement to the ceramic coating 400 from the increased density of the surface regions 414 can be minimized.

FIG. 5B is a cross-sectional view of the aft heat shield 300, taken from a perspective similar to that of FIG. 5A, showing an alternate ceramic coating 430 that can be used on the aft heat shield shown in FIG. 3. The ceramic coating 430 is similar to the ceramic coating 400 shown in FIG. 5A and can have the arrangement of the bulk regions 412 and the surface regions 414 shown in FIG. 4. The ceramic coating 430 shown in FIG. 5B is also a multi-layer coating, including the first layer 422 and the second layer 424, as discussed above. In contrast to the ceramic coating 400 shown in FIG. 5A, the ceramic coating 430 additionally includes a functional layer 432 formed on the second layer 424.

The functional layer 432 can be the outer layer 404 of the ceramic coating 430 and, in such a case, the surface regions 414 are formed in the functional layer 432. In this context, the functional layer 432 can be a layer that serves an additional function beyond thermal insulation. For example, the functional layer 432 can be a calcium-magnesium-alumina-silicate (CMAS) resistant layer or a layer, such as a ceramic layer, that includes a catalyst.

CMAS can form on the heat shield 300 when certain types of environmental contaminants (e.g., dust, sand, or volcanic ash) interact with the high temperatures and pressures within the turbine engine (FIG. 1). The combination of calcium (Ca), magnesium (Mg), and aluminum (Al) with silicates can lead to the formation of a glass-like phase that can deposit on the surface of turbine blades and other high-temperature components. A CMAS resistant layer can be a ceramic layer that contains yttrium (Y), lanthanum (La), or zirconium (Zr), such as, for example, fifty-five percent yttrium oxide (55YSZ) and other rare earth containing oxides.

One functional layer 432 that includes a catalyst can be a ceramic layer that includes or is otherwise formed of a rare earth oxide-based catalyst. The rare earth oxide-based catalyst can inhibit coke deposition and build-up because of the presence of the catalyst. Without intending to be bound to any theory, the functional layer 432, such as the rare earth oxide-based catalyst, can promote the complete or partial oxidation of the coke as it forms. The rare earth oxide-based catalyst can be cerium oxide including CeO₂ or any cerium-based oxide. The rare earth oxide-based catalyst also can be yttrium oxide (including Y₂O₃), praseodymium oxide (Pr₂O₃), lanthanum oxide (including La₂O₃), neodymium oxide (including Nd₂O₃), samarium oxide (including Sm₂O₃), gadolinium oxide (including Gd₂O₃), and terbium oxide (including Tb₄O₇).

The rare earth oxide-based catalyst can include zirconium, hafnium, praseodymium, neodymium, promethium, samarium, europium, gadolinium, terbium, dysprosium, holmium, erbium, thulium, ytterbium, or lutetium. The cerium-based oxide can have a formula of Ce₁₋ₓ(RE)ₓO_{2-δ}, where RE represents the above metals other than cerium, x ranges from 0.1 to 0.5, and 8 ranges from 0 to 0.1 (such as, from ₀ to _{0.5}). Alternatively, the cerium-based oxide may have a formula of Ce_{1-(x+y)}(RE1)ₓ(RE2)_{y}O_{2-δ}, where RE1 and RE2 represent two of the above metals other than cerium, x+y ranges from 0.1 to 0.5, and 8 ranges from 0 to 0.1 (such as, from 0 to 0.5).

Although shown as a separate layer, the rare earth oxide-based catalyst can be formed as catalyst particles that are then integrated into TBC materials, such as by being integrated into the second layer 424 in FIG. 5A.

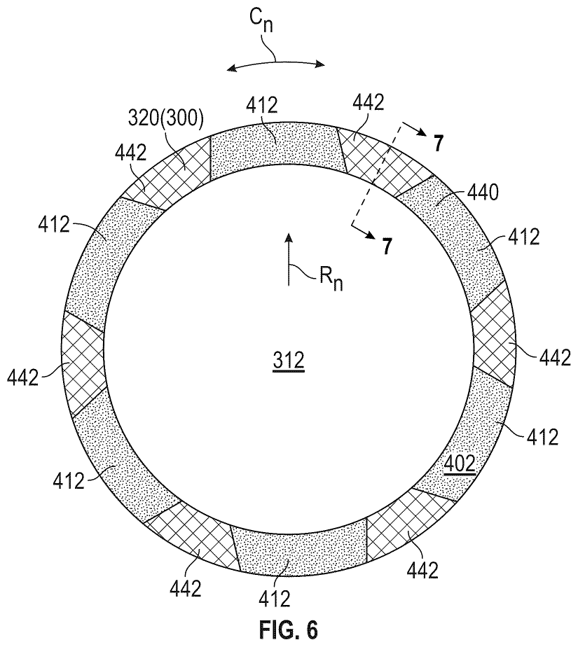

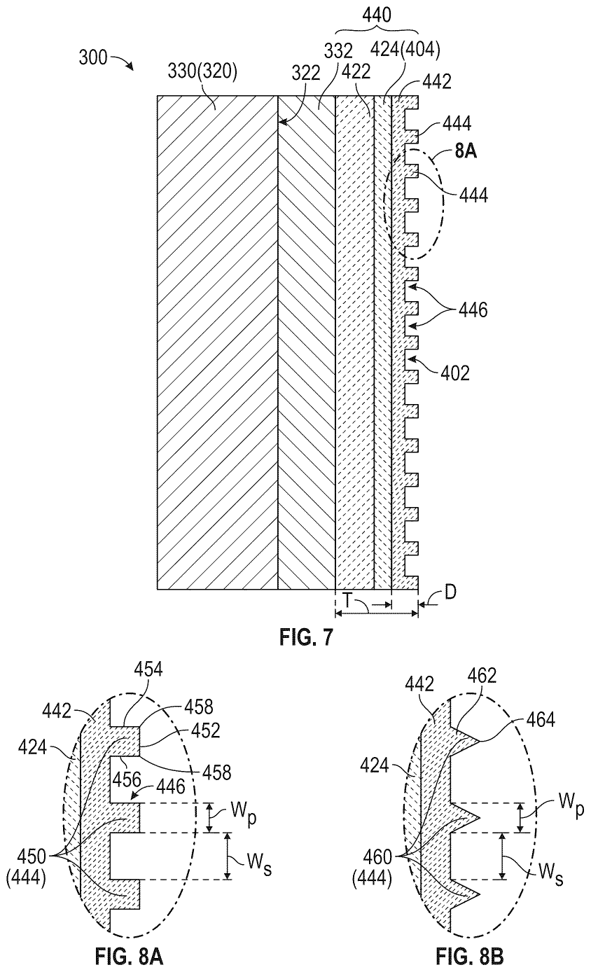

FIG. 6 is a schematic, elevational view of a ceramic coating 440 that can be used as the TBC 324 of the aft heat shield 300 in FIG. 3. More specifically, FIG. 6 shows the hot-side surface 402 of the ceramic coating 440. The ceramic coating 440 shown in FIG. 6 is similar to the ceramic coating 400 discussed above having both bulk regions 412 and surface regions. The surface regions shown in FIG. 6 have a surface texture, including a plurality of projections 444 (FIG. 7) and are referred to herein as patterned surface regions 442. The patterned surface regions 442 are similar to the surface regions 414 (FIG. 4) discussed above having a greater density than the bulk regions 412 and a lesser surface roughness that the bulk regions 412. The patterned surface regions 442 and the bulk regions 412 in FIG. 6 are also arranged similarly to the surface regions 414 and the bulk regions 412 shown in FIG. 4 and discussed above.

FIG. 7 is a cross-sectional view of the aft heat shield 300, taken along line 7-7 in FIG. 6, with the ceramic coating 440 shown in FIG. 6. FIG. 7 is a cross section taken through one of the patterned surface regions 442. As shown in FIG. 7, the ceramic coating 440 is similar to the ceramic coating 400 shown in FIG. 5A with the patterned surface regions 442 being formed in the outer layer 404, which is the second layer 424. The patterned surface regions 442 includes a plurality of projections 444 extending from the hot-side surface 402. The projections 444 are separated from each other, forming a plurality of channels 446 (or recesses) therebetween.

Although shown with the coating structure of FIG. 5A, the surface texture (i.e., the patterned surface regions 442) can also be formed in other ceramic coatings with other coating structures, such as the functional layer 432 discussed above. As will be discussed in more detail below, the projections 444 can have a variety of different shapes. In FIG. 7, each projection 444 of the plurality of projections 444 has the same shape, but the projection 444 can have different shapes from each other. Likewise, each projection 444 of the plurality of projections 444 has the same size and is spaced apart from each other by the same distance, but the projection 444 can have different sizes and spacings from each other.

FIG. 8A is a detail view of a portion of the ceramic coating 440 shown in FIG. 7, showing detail 8A in FIG. 7. The projections 444 can have various, different shapes. For example, the projections 444 can have a rectangular shape or a cylindrical shape. The projections 444 in FIG. 8A are described with a rectangular shape and are referred to herein as rectangular projections 450. Each rectangular projection 450 includes a top surface 452 and a plurality of side surfaces, including a first side surface 454 and a second side surface 456. The top surface 452 connects to each of the first side surface 454 and the second side surface 456 at a vertex 458. Although the vertex 458 shown in FIG. 8A is a right angle with a sharp discontinuity, the right angle with a sharp discontinuity is an idealized configuration and the vertex 458 can have chamfered and rounded corners that can be driven by the ceramic material. With the vertex 458 of the rectangular projection 450 being ninety degrees, the first side surface 454 and the second side surface 456 each form a ninety-degree angle with the hot-side surface 402 of the ceramic coating 440. Other angles can be used such as angles from ninety degrees to one hundred five degrees.

Also, similar to the changes between different regions of the ceramic coating 400 (FIG. 4) discussed above, the texture and projections 444, such as the rectangular projection 450, can help to disrupt the formation of the continuous coke ring. In this context, the surface texture can be a macro texture, where the projections 444 are relatively large and spaced apart from each other, as opposed to, for example, a microscale texture that impacts surface roughness. For example, each projection 444, such as each rectangular projection 450, can have a projection width Wₚ. Additionally, each projection 444, such as each rectangular projection 450, can be spaced apart from each other by a projection spacing Wₛ. The projections 444, such as each rectangular projection 450, can be millimeter scale projections with the projection width Wₚ a millimeter or greater, such as from two (2) millimeters to twenty (20) millimeters. Similarly, the projection spacing Wₛ can be on a millimeter scale with the projection spacing Wₛ from two (2) millimeters to twenty (20) millimeters. The width of each channel 446 can be the same as the projection spacing Wₛ. The projection spacing Wₛ can be the closest distance between adjacent projections 444, such as adjacent rectangular projections 450.

FIG. 8B is a detail view of a portion of the patterned surface regions 442 taken from a perspective similar to that of FIG. 8A, showing an alternate surface texture. As noted above, the projections 444 can have different shapes. For example, the projections 444 can have a conical shape or a pyramidal shape, as shown in FIG. 8B. The projections 444 shown in FIG. 8B are referred to herein as polyhedral projections 460. Each polyhedral projection 460 can include a base 462 and a tip 464. The base 462 can be a portion of the polyhedral projection 460 where the polyhedral projection 460 is connected to the rest of the ceramic layer. The tip 464 can be a portion of the polyhedral projection 460 distal from the base 462. The projection width Wₚ and the projection spacing Wₛ can be measured at the base 462. The tip 464 can form a sharp discontinuity. As shown in FIG. 8B, for example, the polyhedral projection 460 comes to a point at the tip 464, but similar to the vertex above, the point is an idealized configuration and a rounded shape can be used.

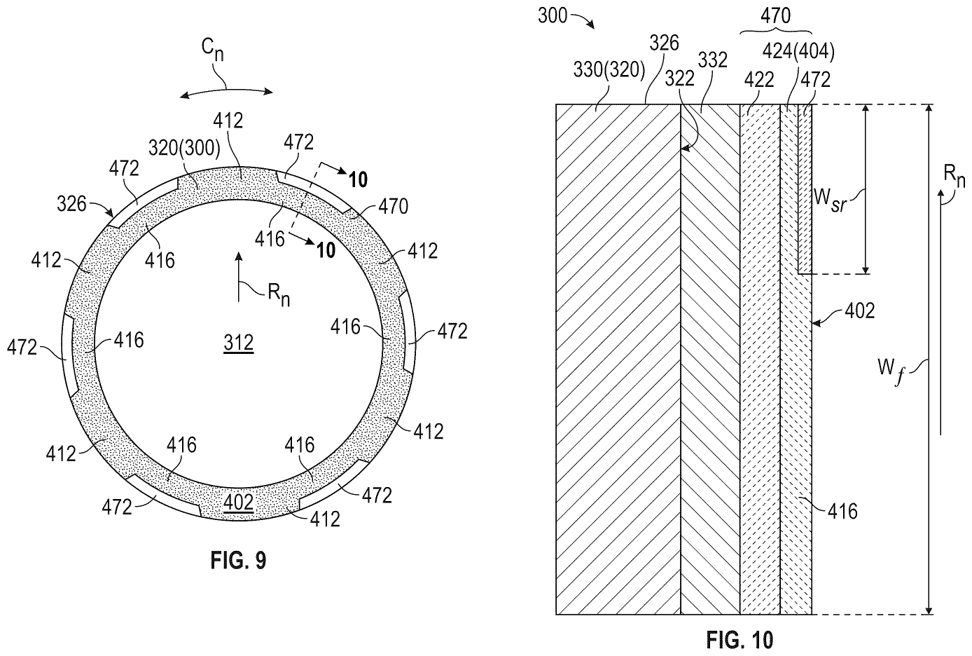

FIG. 9 is a schematic, elevational view of a ceramic coating 470 that can be used as the TBC 324 of the aft heat shield 300 in FIG. 3. More specifically, FIG. 9 shows the hot-side surface 402 of the ceramic coating 470. The ceramic coating 470 shown in FIG. 9 is similar to the ceramic coating 400 discussed above having both a bulk region 412 and surface regions. As noted above, the inventors have observed that the coke ring tends to form on the radially outer portion of the shield flange 320. Accordingly, the surface treatments and the surface regions can be formed on the radially outer portion of the ceramic coating 470. The surface regions shown in FIG. 9 are referred to herein as outer surface regions 472. Each outer surface region 472 is formed on a radially outer portion of the ceramic coating 470. The outer surface region 472 shown in FIG. 9 is described similarly to the surface regions 414 discussed above with reference to FIG. 4. These outer surface regions 472, however, can also have a surface texture similar to the patterned surface regions 442 discussed above with reference to FIG. 6. The outer surface region 472 can be arranged in the nozzle circumferential direction Cn in a manner similar to the surface regions 414 discussed above with reference to FIG. 4 Radially inward from the outer surface region 472, such as between the outer surface region 472 and the heat-shield bore 312, is another bulk region. This bulk region may be referred to herein as an inner bulk region 416. Each inner bulk region 416 can be continuous with adjacent bulk regions 412 that are located adjacent to the outer surface region 472.

FIG. 10 is a cross-sectional view of the aft heat shield 300, taken along line 10-10 in FIG. 9, with the ceramic coating 470 shown in FIG. 9. FIG. 10 is a cross section taken through one of the outer surface regions 472. The shield flange 320 has a width that is the distance from the outer edge 326 of the shield flange 320 to an inner diametrical edge of the shield flange 320.

This width is taken in the nozzle radial direction Rₙ. The width of the shield flange 320 may be referred to herein as the flange width W_{f} or the radial width. The outer surface region 472 also has a radial width, which is referred to herein as the surface region width Wₛᵣ. As can be seen in FIG. 10, each outer surface region 472 has a surface region width Wₛᵣ that is less than the flange width W_{f} in the nozzle radial direction Rₙ. The outer surface region 472 can extend inward from the outer edge 326 and can thus extend inward from the outer edge 326 a distance (the surface region width Wₛᵣ) that is less than the flange width W_{f} in the nozzle radial direction Rn. The outer surface region 472 can thus be formed on the radially outer half of the shield flange 320, such as on the radially outer third of the shield flange 320.

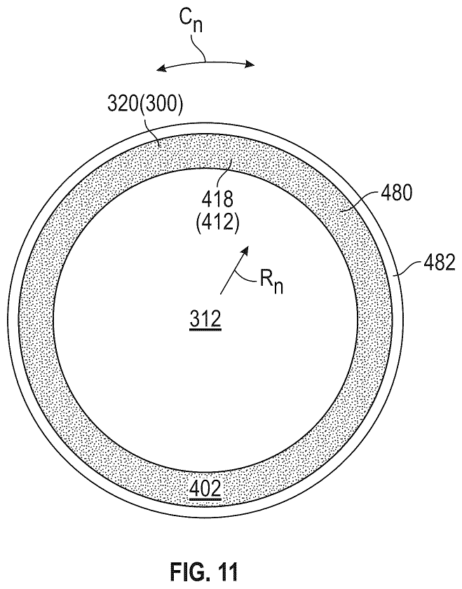

FIG. 11 is a schematic, elevational view of a ceramic coating 480 that can be used as the TBC 324 of the aft heat shield 300 in FIG. 3. More specifically, FIG. 11 shows the hot-side surface 402 of the ceramic coating 480. The ceramic coating 480 is similar to the ceramic coating 470 discussed above with reference to FIGS. 9 and 10, but instead of having a plurality of outer surface regions 472, the ceramic coating 480 includes a singular outer surface region 482 with a bulk region 412 positioned radially inward thereof. The ceramic coating 480 shown in FIG. 11 can include a singular inner bulk region 418 positioned radially inward of the singular outer surface region 482. The singular outer surface region 482 can otherwise be positioned and have the characteristics of the outer surface region 472 discussed above.

The ceramic coatings discussed herein have surface treatments applied thereto to form surface regions that disrupt the formation of coke rings on the aft heat shield. The patterns, arrangements, and characteristics of these surface regions can disrupt coke ring formation preventing damage to downstream components. These surface regions can have a surface roughness less than a surface roughness of a bulk region, a density greater than the density of the bulk region, or both. Additionally, or alternatively, these surface regions can have a surface texture, such as a macro surface texture to further disrupt coke ring formation. Additionally, the surface treatments can be used in conjunction with a functional layer of the ceramic, such as a layer that incorporates a catalyst, to further disrupt coke ring formation.

Further aspects of the present disclosure are provided by the subject matter of the following clauses.

A heat shield for a fuel nozzle of a turbine engine includes a shield flange and a ceramic coating. The shield flange has an axial direction, a radial direction, and a circumferential direction. The shield flange includes a flange hot-side surface. The ceramic coating is formed on the flange hot-side surface. The ceramic coating includes a coating hot-side surface, one or more bulk regions, and one or more surface regions. The one or more surface regions are a portion of the coating hot-side surface of the ceramic coating. Each surface region of the one or more surface regions has a surface roughness less than a surface roughness of each bulk region of the one or more bulk regions, a density greater than the density of each bulk region of the one or more bulk regions, or both.

The heat shield of the preceding clause, wherein the ceramic coating has a total thickness and each surface region of the one or more surface regions has a surface depth from the coating hot-side surface of the ceramic coating that is less than the thickness of the ceramic coating.

The heat shield of the preceding clause, wherein the surface depth of each surface region of the one or more surface regions is from 1.5 percent to 20 percent of the thickness of the ceramic coating.

The heat shield of any preceding clause, wherein the surface depth of each surface region of the one or more surface regions is from 1.5 percent to 10 percent of the thickness of the ceramic coating.

The heat shield of any preceding clause, wherein the surface depth of each surface region of the one or more surface regions is from five μm to fifty μm.

The heat shield of any preceding clause, wherein the surface depth of each surface region of the one or more surface regions is from five μm to twenty-five μm.

The heat shield of any preceding clause, wherein the surface roughness of each surface region of the one or more surface regions is less than the surface roughness of each bulk region of the one or more bulk regions.

The heat shield of the preceding clause, wherein the surface roughness of each bulk region of the one or more bulk regions is from three hundred micro-inches to one thousand micro-inches.

The heat shield of any preceding clause, wherein the surface roughness of each surface region of the one or more surface regions is from one micro-inch to one hundred fifty micro-inches.

The heat shield of any preceding clause, wherein the surface roughness of each surface region of the one or more surface regions is from ten micro-inches to fifty micro-inches.

The heat shield of any preceding clause, wherein the surface roughness of each surface region of the one or more surface regions is from 0.1 percent to 50 percent the surface roughness of each bulk region of the one or more bulk regions.

The heat shield of any preceding clause, wherein the surface roughness of each surface region of the one or more surface regions is from one percent to twenty percent the surface roughness of each bulk region of the one or more bulk regions.

The heat shield of any preceding clause, wherein the density of each surface region of the one or more surface regions is greater than the density of each bulk region of the one or more bulk regions.

The heat shield of the preceding clause, wherein the density of each bulk region of the one or more bulk regions is from sixty-five percent to ninety percent by volume percent of the bulk region.

The heat shield of any preceding clause, wherein the density of each surface region of the one or more surface regions is from eighty percent to ninety-eight percent by volume percent of the surface region.

The heat shield of the preceding clause, wherein the density of each bulk region of the one or more bulk regions is from sixty-five percent to ninety-five percent of the density of the surface region, the density of each bulk region being determined by volume percent of each bulk region and the density of the surface region being determined by volume percent of the surface region.

The heat shield of any preceding clause, wherein the ceramic coating comprises a plurality of layers in a thickness direction of the ceramic coating, each layer of the plurality of layers comprising a different composition of ceramic material.

The heat shield of the preceding clause, wherein the plurality of layers includes an outer layer on which the coating hot-side surface is formed, the outer layer being a functional layer comprising a ceramic material that includes a catalyst to catalyze a coke reaction.

The heat shield of any preceding clause, wherein the shield flange has a width in the radial direction and includes a radially outer edge, each surface region of the one or more surface regions extending inward from the radially outer edge a distance that is less than the width of the shield flange in the radial direction.

The heat shield of any preceding clause, wherein the shield flange has a width in the radial direction, and each surface region of the one or more surface regions has a width in the radial direction that is less than the width of the shield flange in the radial direction.

The heat shield of the preceding clause, wherein each surface region of the one or more surface regions is formed on the radially outer half of the shield flange radially outward of at least a portion of the one or more bulk regions.

The heat shield of any preceding clause, wherein each surface region of the one or more surface regions is formed on the radially outer third of the shield flange radially outward of at least a portion of the one or more bulk regions.

The heat shield of the preceding clause, wherein the ceramic coating includes a singular, one of the surface regions.

The heat shield of any preceding clause, wherein the ceramic coating includes a plurality of the surface regions spaced apart from each other in the circumferential direction.

The heat shield of any preceding clause, further comprising a plurality of surface regions spaced apart from each other in the circumferential direction.

The heat shield of the preceding clause, wherein the shield flange has a width in the radial direction, and each surface region of the one or more surface regions extends the width of the shield flange in the radial direction.

The heat shield of any preceding clause, wherein each surface region of the one or more surface regions has a surface texture, including a plurality of projections.

The heat shield of the preceding clause, wherein each projection of the plurality of projections has the same shape.

The heat shield of any preceding clause, wherein the surface texture is a macro texture with each projection having a width from two millimeters to twenty millimeters.

The heat shield of any preceding clause, wherein each projection of the plurality of projections has the same width.

The heat shield of any preceding clause, wherein the surface texture is a macro texture with each projection being spaced apart from each other by a spacing distance, the spacing distance being from two millimeters to twenty millimeters.

The heat shield of any preceding clause, wherein each projection of the plurality of projections has the spacing distance.

The heat shield of any preceding clause, wherein each projection of the plurality of projections has a height, the height being from one mil to ten mils.

The heat shield of any preceding clause, wherein each projection of the plurality of projections has a height, the height being from one mil to four mils.

The heat shield of any preceding clause, wherein each projection of the plurality of projections has the same height.

The heat shield of any preceding clause, wherein each projection of the plurality of projections has the same size.

The heat shield of any preceding clause, wherein the shield flange is a portion of a flange.

The heat shield of any preceding clause, further comprising in inner wall, the flange being attached to the inner wall.

A fuel nozzle for a turbine engine includes a fuel nozzle tip including a distal end, and the heat shield of any preceding clause, attached to the distal end of the fuel nozzle tip.

A combustor for a turbine engine includes an inner combustion liner, an outer combustion liner, and a mixer assembly. The outer combustion liner is positioned opposite the inner combustion liner to define a combustion chamber therebetween. The combustion chamber includes an upstream end. The mixer assembly is located at the upstream end of the combustion chamber and includes the fuel nozzle of any preceding clause.

Although the foregoing description is directed to certain embodiments, other variations and modifications will be apparent to those skilled in the art and may be made without departing from the disclosure. Moreover, features described in connection with one embodiment may be used in conjunction with other embodiments, even if not explicitly stated above.

1. A heat shield for a fuel nozzle of a turbine engine, the heat shield comprising:
a shield flange having an axial direction, a radial direction, and a circumferential direction, the shield flange including a hot side and a cold side, with a flange hot-side surface located on the hot side of the shield flange; and
a ceramic coating formed on the flange hot-side surface of the shield flange for insulating components on the cold side of the shield flange from heat of combustion, the ceramic coating comprising a plurality of regions including one or more bulk regions and one or more surface regions, each surface region of the one or more surface regions having a surface roughness less than a surface roughness of each bulk region of the one or more bulk regions, a density greater than a density of each bulk region of the one or more bulk regions, or both,
wherein a bulk region of the one or more bulk regions is adjacent to a surface region of the one or more surface regions in an alternating arrangement to disrupt formation of coke on the ceramic coating.

2. The heat shield of claim 1, wherein the density of each surface region of the one or more surface regions is greater than the density of each bulk region of the one or more bulk regions.

3. The heat shield of claim 1, wherein the ceramic coating further comprises a plurality of the surface regions spaced apart from each other in the circumferential direction.

4. The heat shield of claim 1, wherein the ceramic coating further comprises a coating hot-side surface and a plurality of layers in a thickness direction of the ceramic coating, each layer of the plurality of layers comprising a different composition of ceramic material.

5. The heat shield of claim 4, wherein the plurality of layers includes an outer layer defining the coating hot-side surface, the outer layer being a functional layer comprising a ceramic material that includes a catalyst to catalyze a coke reaction.

6. The heat shield of claim 4, wherein the ceramic coating has a total thickness and each surface region of the one or more surface regions has a surface depth from the coating hot-side surface of the ceramic coating that is less than the total thickness of the ceramic coating.

7. The heat shield of claim 6, wherein the surface depth of each surface region of the one or more surface regions is from 1.5 percent to ten percent of the total thickness of the ceramic coating.

8. The heat shield of claim 6, wherein the surface depth of each surface region of the one or more surface regions is from five μm to twenty-five μm.

9. The heat shield of claim 1, wherein each surface region of the one or more surface regions is formed on a radially outer third of the shield flange radially outward of at least a portion of each bulk region of the one or more bulk regions.

10. The heat shield of claim 9, wherein the plurality of regions includes a single surface region of the one or more surface regions.

11. The heat shield of claim 9, wherein the ceramic coating further comprises plurality of the surface regions spaced apart from each other in the circumferential direction.

12. The heat shield of claim 1, wherein each surface region of the one or more surface regions has a surface texture including a plurality of projections.

13. The heat shield of claim 12, wherein each projection of the plurality of projections has an identical shape.

14. The heat shield of claim 12, wherein the surface texture is a macro texture with each projection having a width from two millimeters to twenty millimeters, each projection being spaced apart from each other by a spacing distance, the spacing distance being from two millimeters to twenty millimeters, or both.

15. The heat shield of claim 1, wherein the surface roughness of each surface region of the one or more surface regions is less than the surface roughness of each bulk region of the one or more bulk regions.

16. The heat shield of claim 15, wherein the surface roughness of each bulk region of the one or more bulk regions is from three hundred micro-inches to one thousand micro-inches.

17. The heat shield of claim 15, wherein the surface roughness of each surface region of the one or more surface regions is from one micro-inch to one hundred fifty micro-inches.

18. The heat shield of claim 15, wherein the surface roughness of each surface region of the one or more surface regions is from ten micro-inches to fifty micro-inches.

19.-20. (canceled)

21. The heat shield of claim 6, wherein the surface depth of each surface region of the one or more surface regions is from 1.5 percent to twenty percent of the total thickness of the ceramic coating.

22. The heat shield of claim 6, wherein the surface depth of each surface region of the one or more surface regions is from five μm to fifty μm.
